(19) United States
(12) Patent Application Publication
(10) Pub. No.: US 2018/0098666 A1
(43) Pub. Date: Apr. 12, 2018

(54) BLENDER JAR ASSEMBLY AND COVER FOR BLENDER JAR ASSEMBLY

(71) Applicant: Wen-Ching LEE, TAICHUNG CITY (TW)

(72) Inventor: Wen-Ching LEE, TAICHUNG CITY (TW)

(21) Appl. No.: 15/710,166

(22) Filed: Sep. 20, 2017

(30) Foreign Application Priority Data
Oct. 12, 2016 (TW) 105132926

(51) Int. Cl. A47J 43/07; B65D 81/20; B65B 31/04; B65D 41/04

(52) U.S. Cl. CPC A47J 43/0716; B65D 41/0421; B65B 31/047; B65D 81/2038

(57) ABSTRACT

A blender jar assembly consisting of a blender jar, a cover and a vacuum pump is disclosed. The cover includes a cover body including a connection channel and a locking system formed on the cover body within the connection channel, and a sealing plug set detachably connected to the cover body and locked thereto by the locking system to cover the connection channel and having an air hole and an air valve adapted for blocking the air hole. Thus, the sealing plug set can be selectively mounted in the cover body, and the connection channel can be provided for accommodating a measuring cup or for the insertion of a stirring rod.

### BACKGROUND OF THE INVENTION

### 1. Field of the Invention

The present invention relates to airtight cover designs and more particularly, to a blender jar assembly and its cover.

### 2. Description of the Related Art

Blenders, juicers and slow juicers are adapted for processing vegetables, fruits, nuts and other food into easy-to-eat juice. To the fruit, for example, when the fruit is processed into juice, the juice thus produced will be reacted with oxygen in the air inside the jar and turned into an oxidized color, and the food nutrition will be lost, so, it not only affects appetite, but also affects the taste of the food.

Further, a cover for covering a food processing container generally has a connection channel for accommodating a measuring cup. After insertion of a measuring cup into the connection channel, there is still a clearance kept between the measuring cup and the connection channel for air circulation between the inside of the food processing container and the atmosphere. In application, the measuring cup is removed so that a stirring rod can be inserted through the connection channel into the food processing container to stir up food ingredients. During stirring, outside air can flow into the inside of the food processing container to accelerate the oxidation reaction.

Therefore, many cover designs that eliminate a connection channel and a measuring cup have been created for closing a jar of a blender, juicer or slow juicer for allowing the operation of a vacuum pump to draw air out of the jar so as to reduce oxidation of the juice in the jar. For example, China Patent No. CN 204120771U and China Patent Publication No. CN 103720339A disclose different cover designs that eliminate the arrangement of a measuring cup and a connection channel.

However, these commercial vacuum juicers need the use of a specially designed closed cover that does not allow insertion of a stirring rod into the jar, therefore, for certain food ingredients that are not easy to stir, this design of vacuum juicers will not be effective for food processing.

### SUMMARY OF THE INVENTION

The present invention has been accomplished under the circumstances in view. It is therefore the main object of the present invention to provide a blender jar assembly and a cover for the blender jar assembly, wherein the cover has a connection channel that is adapted for accommodating a measuring cup or for the insertion of a stirring rod and can be fastened with a sealing plug set to achieve an airtight effect for enabling a vacuum pump to perform a vacuuming operation.

To achieve this and other objects of the present invention, a cover is provided for covering an opening of a jar. The cover comprises a cover body and a sealing plug set. The cover body comprises a connection channel and a locking system. The locking system is formed on the cover body within the connection channel. The sealing plug set is detachably connectable to the cover body. Further, the sealing plug set is connected to the cover body by means of the locking system, and covered over the connection channel. Further, the sealing plug set comprises at least one air hole and an air valve. The air valve is adapted for blocking the at least one air hole.

To achieve this and other objects of the present invention, a blender jar assembly comprises a vacuum pump, a blender jar, and the above-described cover.

To achieve this and other objects of the present invention, a cover is provided and covered over an opening of a jar. The cover comprises at least one air hole, an air valve blocking the at least one air hole, and a vacuum pump mounted thereon for performing a vacuuming process to draw air out of the jar through the air valve and to further create a negative pressure in the jar. The cover further comprises a cover body and a sealing plug set. The cover body comprises a top surface, an opposing bottom surface, and a connection channel cut through the top surface and the bottom surface. The sealing plug set covers the connection channel, comprising a sealing device located at the top surface of the cover body. After vacuuming process of the vacuum pump to create the negative pressure in the jar, the sealing device is sucked by the negative pressure and secured to the top surface of the cover body in an airtight manner.

Thus, the sealing plug set of the present invention can be selectively mounted at the cover body, and a commercial measuring cup can be inserted into the connection channel of the cover body for enabling the stirring rod to pass through the connection channel.

Other advantages and features of the blender jar assembly and the cover of the present invention will be fully understood by reference to the following specification in conjunction with the accompanying drawings, in which like reference signs denote like components of structure.

### BRIEF DESCRIPTION OF THE DRAWINGS

FIG. 1 is a schematic drawing illustrating the outer appearance of a blender jar assembly in accordance with the present invention.

FIG. 2 is a top view of the cover body of the blender jar assembly in accordance with the present invention.

FIG. 3 is a sectional elevational view of the cover body of the blender jar assembly in accordance with the present invention.

FIG. 4 is a sectional view taken along line 4-4 of FIG. 2.

FIG. 5 is a bottom view of the cover body of the blender jar assembly in accordance with the present invention.

FIG. 6 is an oblique elevational view of the sealing plug set of the blender jar assembly in accordance with the present invention.

FIG. 7 is a top view of FIG. 6.

FIG. 8 is a sectional view taken along line 8-8 of FIG. 7.

FIG. 9 is an exploded view of the cover body and sealing plug set of the cover of the blender jar assembly in accordance with the present invention.

FIG. 10 is a sectional view of a part of the assembly of the sealing plug set and the cover body, illustrating the lower protruding block at the start point of the associating second leg.

FIG. 11 is a sectional view of a part of the assembly of the sealing plug set and the cover body, illustrating the lower protruding block tightly abutted against the associating second leg.

FIG. 12 is a sectional view of the present invention, illustrating the sealing plug set and the cover body locked together.

FIG. 13 is a schematic sectional view of the present invention, illustrating the air valve of the cover opened from the air holes during a vacuuming operation of the vacuum pump.

### DETAILED DESCRIPTION OF THE INVENTION

A preferred embodiment of a blender jar assembly in accordance with the present invention is described hereinafter in conjunction with the annexed drawings. However, the components, dimension and outer appearance illustrated in the annexed drawings are simply for illustration purpose only but not intended to limit the technical features of the present invention.

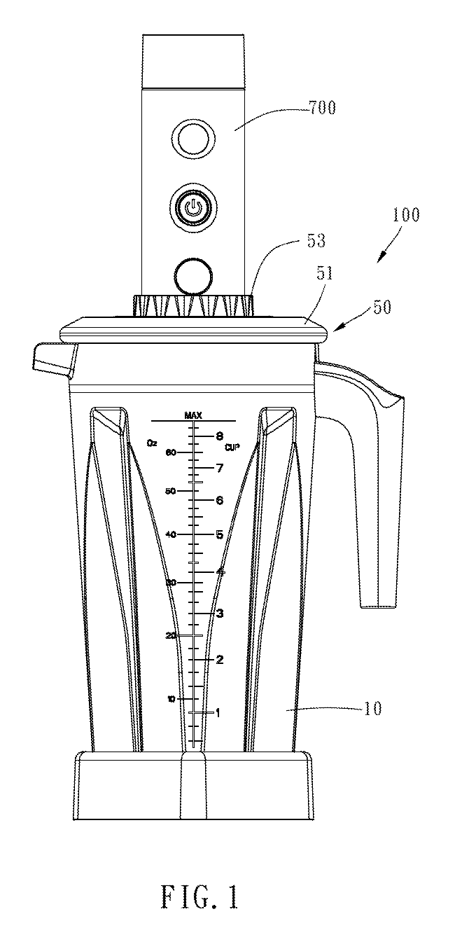

Referring to FIG. 1, a blender jar assembly in accordance with the present invention is shown. The blender jar assembly generally comprises a blender jar 100, a vacuum pump 700 and a cover 50. The blender jar 100 comprises a jar body 10 and a stirrer (not shown). The stirrer is mounted in the jar body 10, and rotatable relative to the jar body 10. Further, the stirrer can be made in the form of a cutter. The jar body 10 is a container, having an opening 11 (not shown).

The cover 50 covers the opening of the jar body 10. Further, the cover 50 has a plurality of close-fitting structures located around the periphery thereof to abut against an inside wall of the jar body 10 to form an airtight seal. Further, the cover 50 can cover the opening of the jar body 10 by: inserting a part of the cover 50 into the inside of the jar body 10, threading an inner/outer thread of the cover 50 into/onto an outer/inner thread of the jar body 10, or operating a locking device to lock the cover 50 to the jar body 10, in other words, the cover 50 can be covered on the opening 11 of the jar body 10 in an airtight manner using any of a variety of known techniques. Thus, the shape of the cover 50 is not limited to what is illustrated in the annexed drawings.

The cover 50 comprises a cover body 51 and a sealing plug set 53. The sealing plug set 53 is detachably connected to the cover body 51. The vacuum pump 700 is adapted for connection to the sealing plug set 53 for the implementation of a vacuuming operation.

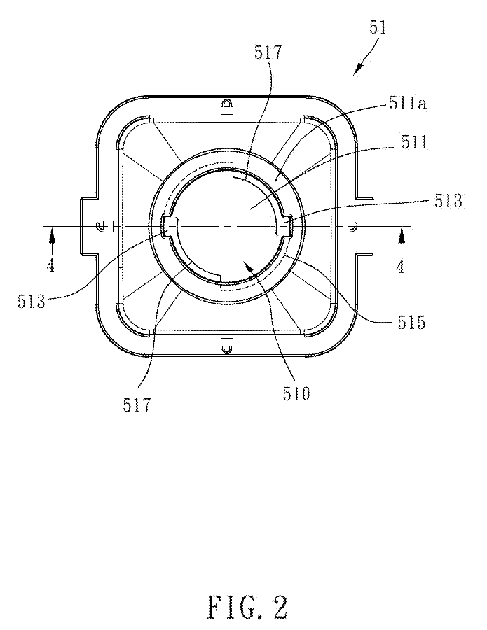

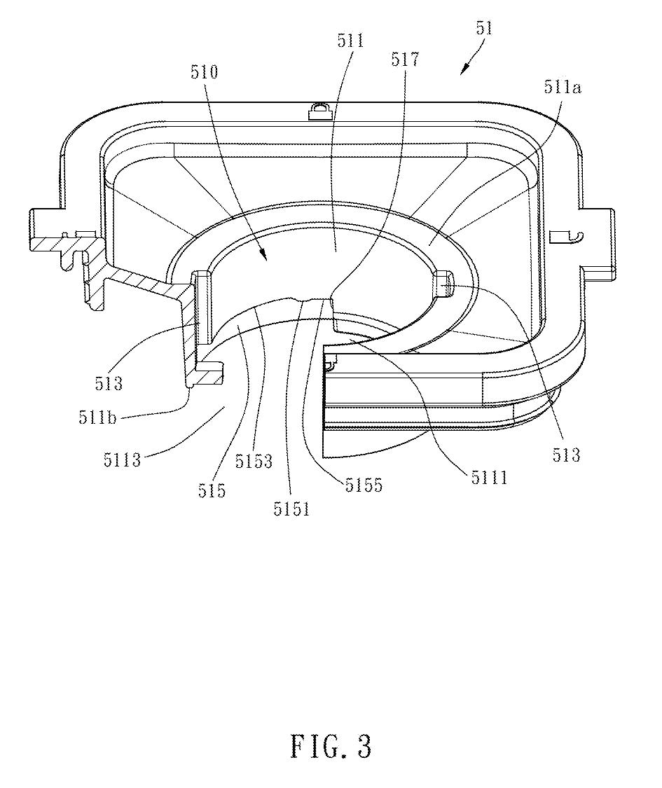

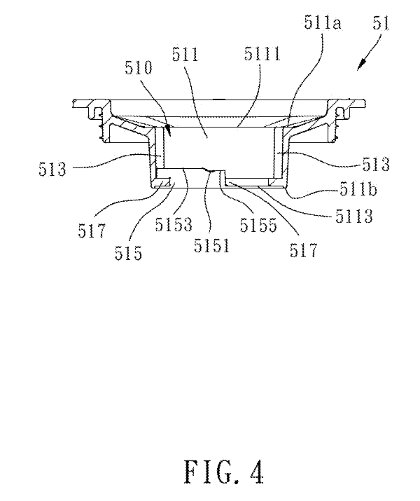

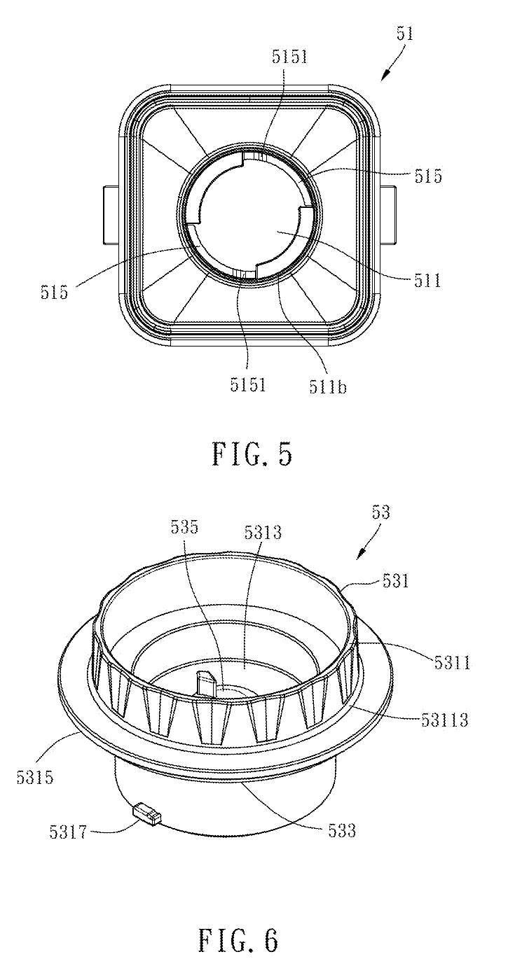

FIG. 2 is a top view of the cover body 51; FIG. 3 is a sectional elevational view of the cover body 51; FIG. 4 is a sectional view taken along line 4-4 of FIG. 2; FIG. 5 is a bottom view of the cover body 51.

As illustrated in FIGS. 2-5, the cover body 51 comprises a top surface 511a, a bottom surface 511b, a connection channel 511, two first legs 513, two second legs 515 and two stop edges 517. The connection channel 511 cut through the top surface 511a and bottom surface 511b of the cover body 51, defining an inlet 5111 and an outlet 5113. The two first legs 513, the two second legs 515 and the two stop edges 517 constitute a locking system 510 of the cover body 51. The two first legs 513 respectively extend from the inlet 5111 of the connection channel 511 toward the outlet 5113 of the connection channel 511, i.e., these two first legs 513 extend vertically downwardly from the inlet 5111 of the connection channel 511. The two second legs 515 are respectively connected to the two first legs 513. Further, these two second legs 515 respectively horizontally extends toward the respective first legs 513. The two stop edges 517 are respectively connected to the second legs 515. The two first legs 513 and the two second legs 515 exhibit a perpendicular relationship therebetween. Further, the number of the first legs 513 and second legs 515 of the locking system 510 can be more than two, i.e., the number of the first legs 513 and second legs 515 is not limited to 2.

Further, the top surface 511a of the cover body 51 can be a plane around the connection channel 511; alternatively, the top surface 511a can be the whole top surface of the cover body 51; therefore, the area of the top surface 511a is not limited to the plane around the connection channel 511 as illustrated in the present preferred embodiment. The bottom surface 511b is a surface of the cover body 51 opposite to the top surface 511a, therefore, the bottom surface 511b is not limited to the area as illustrated in the annexed drawing.

As illustrated in FIG. 2, the two first legs 513 are disposed opposite to each other; the two second legs 515 are disposed opposite to each other; the two stop edges 517 are disposed opposite to each other. In the present preferred embodiment, the two first legs 513, the two second legs 515 and the stop edges 517 are respectively identical.

Referring to FIGS. 3-5 again, the two second legs 515 each comprise a positioning portion 5151. In the present preferred embodiment, the positioning portion 5151 is a bump. The two second legs 515 each further comprise a first supporting surface 5153 and a second supporting surface 5155. The first supporting surfaces 5153 of the second legs 515 are respectively extended from the first legs 513 to respective front sides of the associating positioning portions 5151. The second supporting surfaces 5155 of the second legs 515 are respectively extended from respective opposing rear sides of the associating positioning portions 5151 to the respective stop edges 517. Further, the second supporting surfaces 5155 are disposed below the elevation of the two first supporting surfaces 5153.

In the present preferred embodiment, the two second legs 515 are disposed adjacent to the outlet 5113 of the connection channel 51, however, in actual application, the two second legs 515 can be disposed at any locations remote from the inlet 5111 of the connection channel 511, for example, the two second legs 515 can be located on the bottom surface of the connection channel 511.

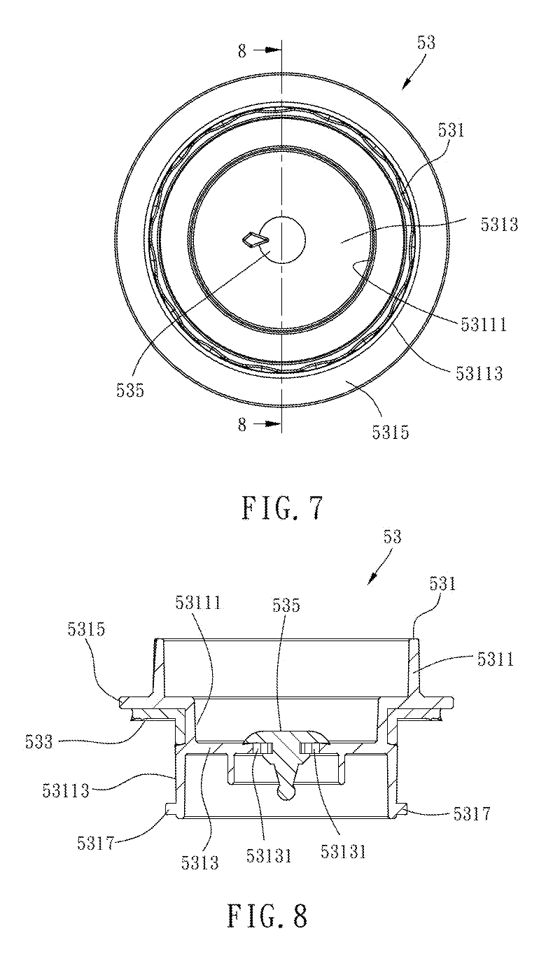

FIG. 6 is an oblique elevational view of the sealing plug set; FIG. 7 is a top view of FIG. 6; FIG. 8 is a sectional view taken along line 8-8 of FIG. 7.

As illustrated in FIGS. 6-8, the sealing plug set 53 comprises an adapter 531, a sealing device 533 and an air valve 535. The adapter 531 comprises a hollow annular wall 5311, a partition wall 5313, an upper flange 5315 and two lower protruding block 5317. The partition wall 5313 is connected to the hollow annular wall 5311, and extended from an inner wall surface 53111 of the hollow annular wall 5311. The upper flange 5315 is connected to the hollow annular wall 5311, and extended horizontally outwardly around the periphery of the hollow annular wall 5311. The two lower protruding blocks 5317 are respectively connected to the hollow annular wall 5311, and extended horizontally outwardly from an outer wall surface 53113 of the hollow annular wall 5311.

Further, the hollow annular wall 5311 can be a smooth circular wall, or an annular wall with a multi-angle geometric design, i.e., the inner wall surface 53111 and outer wall surface 53113 of the hollow annular wall 5311 can be flat vertical surfaces or irregular surfaces. In the present preferred embodiment, the hollow annular wall 5311 exhibits a multi-angle geometric design, however, this design is not a limitation. Further, the top of the hollow annular wall 5311 is configured to work as a grip.

Referring to FIG. 8, the partition wall 5313 has a plurality of air holes 53131. These air holes 53131 cut through the partition wall 5313. The sealing device 533 is connected to the hollow annular wall 5311 and upper flange 5315 of the adapter 531, and disposed between the upper flange 5315 and the lower protruding blocks 5317. The air valve 535 is connected to the partition wall 5313 of the adapter 531 to block the air holes 53131 of the adapter 531. The sealing device 533 and the air valve 535 are preferably made by soft rubber, such as natural rubber, synthetic rubber or silicone rubber that is capable of achieving an airtight effect.

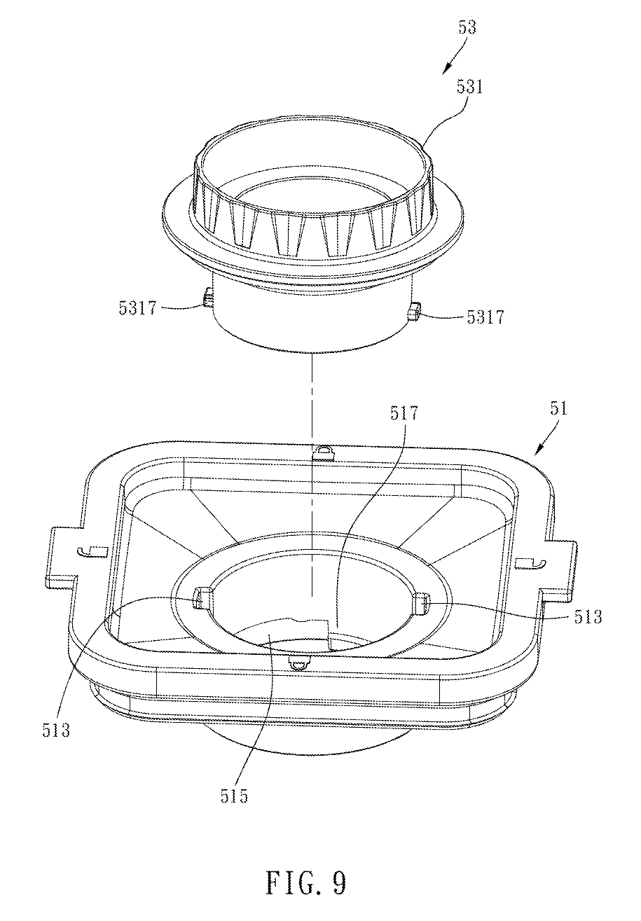

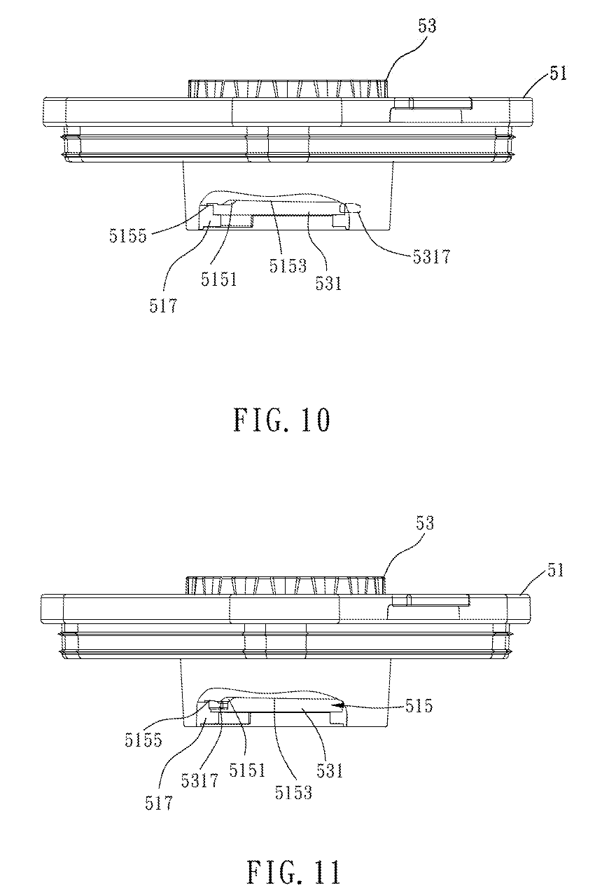

FIG. 9 is an exploded view of the cover body 51 and sealing plug set 53 of the cover 50 of the blender jar assembly; FIG. 10 is a sectional view of a part of the assembly of the sealing plug set 53 and the cover body 50, illustrating the lower protruding block 5317 at the start point of the associating second leg 515; FIG. 11 is a sectional view of a part of the assembly of the sealing plug set 53 and the cover body 51, illustrating the lower protruding block 5317 tightly abutted against the second supporting surface 5155 of the associating second leg 515.

As illustrated in FIG. 9, the two lower protruding blocks 5317 of the sealing plug set 53 of the adapter 531 are respectively aimed at the two first legs 513 of the cover body 51, and then, as illustrated in FIG. 10, the sealing plug set 53 is pressed down to move the two lower protruding blocks 5317 of the adapter 531 along the respective first legs 513 to the start points of the respective second legs 515, and then, as illustrated in FIG. 11, the sealing plug set 53 is rotated to move the two lower protruding blocks 5317 of the adapter 531 from the start points of the respective second legs 515 to the end points of the respective second legs 515, i.e., to the lower protruding blocks 5317 to abut against the second supporting surface 5155 of the respective second legs 515, and thus, the sealing plug set 53 and the cover body 51 are locked together.

The positioning portions 5151 of the cover body 51 each have a chamfered edge at the front side so that the two lower protruding blocks 5317 of the adapter 531 can be easily moved along the chamfered edges of the respective positioning portions 5151 to the second supporting surfaces 5155 of the respective second legs 515 into abutment against the respective stop edges 517.

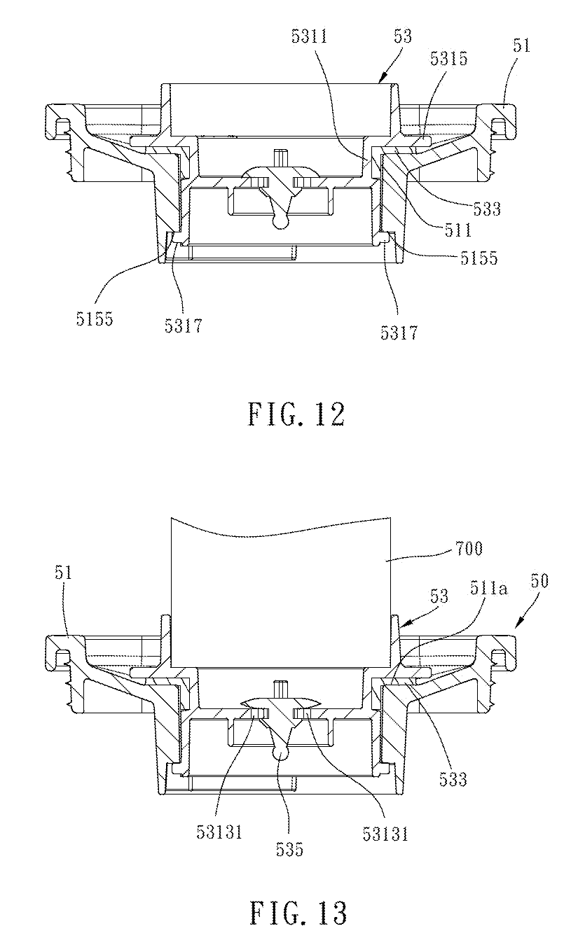

FIG. 12 is a sectional view, illustrating the sealing plug set 53 and the cover body 51 fastened together. When the cover body 51 and the sealing plug set 53 are fastened together, the sealing plug set 53 blocks the connection channel 511 of the cover body 51, and the sealing device 533 is abutted against the cover body 51. Since the second supporting surfaces 5155 of the second legs 515 are disposed below the elevation of the first supporting surfaces 5153, as illustrated in FIG. 11, the lower protruding blocks 5317 are tightly abutted against the respective second supporting surfaces 5155 and the upper flange 5315 is pressed on the sealing device 533 when the cover body 51 and the sealing plug set 53 are fastened together, and thus, the sealing device 533 is elastically deformed and squeezed in between the upper flange 5315 and the cover body 51 tightly.

Thus, the sealing plug set 53 is locked to the cover body 51 with the sealing device 533 held down tightly by the hollow annular wall 5311 and upper flange 5315 of the adapter 531 of the sealing plug set 53 and the cover body 51 to achieve an airtight effect.

In the present preferred embodiment, the sealing plug set 53 is inserted through the top surface of the cover body 51 into the inside of the cover body and then locked in position by the locking system. However, in actual application, the sealing plug set 53 can be configured for insertion through the bottom surface of the cover body 51 into the inside of the cover body and then locked in position by the locking system. Therefore, the connection between the sealing plug set 53 and the cover body 51 can be achieved by the method described above, other locking system designs can be selectively used to achieve connection between the sealing plug set 53 and the cover body 51 without departing from the spirit and scope of the present invention.

Referring to FIG. 13, the vacuum pump 700 can be mounted in the sealing plug set 53 of the cover 50 and operated to draw air out of the blender jar assembly. When a vacuuming operation is performed, the air valve 535 is partially elastically deformed to open the air holes 53131, enabling the internal air to be drawn out of the jar body to create a vacuum so that the food ingredients and fluid in the jar body can be maintained fresh.

It should be noted that, during the vacuuming operation, the negative pressure in the jar body 10 of the blender jar 100 thus created will suck the sealing plug set 53 to achieve airtight connection between the sealing device 533 of the sealing plug set 53 and the top surface 511a of the cover body 51, maintaining the negative pressure in the jar body 10 of the blender jar 100. The negative pressure means the internal air of the jar body 10 of the blender jar 100 has been drawn out of the jar body 10 through the air holes 53131 by the vacuum pump 700 to create a vacuum in the jar body 10 of the blender jar 100.

The cover body locking system can be omitted when the sealing device 533 is used to achieve airtight connection between the sealing plug set 53 and the cover body 51, that is, before creation of a vacuum in the jar body 10 of the blender jar 100, the sealing plug set 53 is not fixedly connected with the cover body 51; after creation of a vacuum in the jar body 10 of the blender jar 100, the sealing device 533 is naturally sucked by the negative pressure, achieving airtight connection between the sealing plug set 53 and the cover body 51.

Finally, upon completion of the vacuuming operation, the vacuum pump 700 can be separated from the cover 50, and the air valve 535 returns to the state shown in FIG. 12 to block the air holes 53131, maintaining the negative pressure condition inside the jar body 10 of the blender jar 100.

In the present preferred embodiment, the connection between the cover body 51 and the sealing plug set 53 is achieved by means of the locking system of the cover body 51 and the two lower protruding blocks 5317 of the sealing plug set 53. However, in actual application, any other equivalent structure such as screw threads can be employed to substitute for the locking system; in this case, the sealing plug set 53 is configured to provide a mating thread for engagement with the thread of the locking system of the cover body 51. Thus, the locking system and the connection structure of the sealing plug set 53 are not limited to the above-described design of the present preferred embodiment.

Further, if the two lower protruding blocks are respectively located at the two second legs for enabling the cover body and the sealing plug set to be connected in an airtight manner. In this case, the two stop edges can be omitted. Further, the sealing device is adapted to achieve airtight connection between the cover body and the adapter, thus, the sealing device can be an O-ring, and the number is not limited to 1.

In the present preferred embodiment, the air holes and the air valve are located at the sealing plug set, however, in actual application, the air holes and the air valve can be located at the cover body. The sealing plug set can be connected to the cover body by the locking system to achieve airtight connection with the cover body, or, an airtight connection between the sealing plug set and the cover body can be achieved upon creation of a negative pressure to suck the sealing plug set, and thus, the air holes and the air valve can be located at the cover body without limiting to the positioning design of the preferred embodiment.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A cover for covering an opening of a jar, comprising:
a cover body comprising a connection channel and a locking system, said locking system being formed on said cover body within said connection channel; and
a sealing plug set detachably connectable to said cover body, said sealing plug set being connectable by said locking system of said cover body to cover said connection channel of said cover body, said sealing plug set comprising at least one air hole and an air valve, said air valve being adapted for blocking said air hole.

2. The cover as claimed in claim 1, wherein said sealing plug set further comprises an upper flange and two lower protruding blocks, said upper flange being adapted for pressing on said cover body, said lower protruding blocks being disposed below the elevation of said upper flange and adapted for abutting against said locking system tightly.

3. The cover as claimed in claim 2, wherein said connection channel defines an inlet and an opposing outlet; said locking system comprises two first legs and two second legs, said first legs being respectively extended from said inlet of said connection channel toward said outlet for the passing of said lower protruding blocks, said second legs being respectively horizontally extended from said first legs and adapted for abutting against the respective said lower protruding blocks tightly.

4. The cover as claimed in claim 3, wherein said second legs each comprise a first supporting surface, a second supporting surface and a positioning portion, the said two first supporting surfaces being respectively extended from the said two first legs to respective front edges of the associating said positioning portions, the two said second supporting surfaces being respectively backwardly extended from respective opposing rear edges of the associating positioning portions, the two said lower protruding blocks being respectively abutted against the respective said second supporting surfaces.

5. The cover as claimed in claim 4, wherein said locking system comprises two stop edges respectively located at respective rear sides of the respective said second legs.

6. The cover as claimed in claim 3, wherein the front edge of each said positioning portion is a chamfered edge.

7. The cover as claimed in claim 3, wherein said locking system comprises two stop edges respectively located at respective rear sides of the respective said second legs.

8. The cover as claimed in claim 2, wherein said sealing plug set comprises an adapter and a sealing device, said adapter being connected to said upper flange and said two lower protruding blocks, said sealing device being connected to said adapter and said upper flange and disposed between said upper flange and said two lower protruding blocks and abutted against a top surface of said cover body; said at least one air hole is located in said adapter; said air valve is connected to said adapter.

9. A blender jar assembly, comprising:
a vacuum pump;
a blender jar; and
a cover as claimed in claim 1.

10. A cover covering an opening of a jar and comprising at least one air hole, an air valve blocking said at least one air hole and a vacuum pump mounted thereon for performing a vacuuming process to draw air out of said jar through said air valve and to further create a negative pressure in said jar, wherein said cover comprises:
a cover body comprising a top surface, an opposing bottom surface and a connection channel cut through said top surface and said bottom surface; and
a sealing plug set covering said connection channel, said sealing plug set comprising a sealing device located at the said top surface of said cover body, said sealing device being sucked by said negative pressure and secured to the said top surface of said cover body in an airtight manner after said vacuuming process of said vacuum pump to create said negative pressure in said jar.

11. The cover as claimed in claim 10, wherein said sealing plug set further comprises an adapter; said sealing device is connected to a peripheral edge of said adapter and pressed on the said top surface of said cover body; said at least one air hole is located in said adapter; said air valve is connected to said adapter.

12. The cover as claimed in claim 10, wherein said cover body further comprises a locking system, said locking system being formed on said cover body within said connection channel; said sealing plug set is detachably connectable to said cover body; said sealing plug set is connected to said cover body by said locking system to cover said connection channel of said cover body; said sealing device is abutted against the said top surface of said cover body.

13. The cover as claimed in claim 12, wherein said sealing plug set further comprises an upper flange and two lower protruding blocks, said upper flange being adapted for pressing on said cover body, said lower protruding blocks being disposed below the elevation of said upper flange and adapted for abutting against said locking system tightly.

14. The cover as claimed in claim 13, wherein said connection channel defines an inlet and an opposing outlet; said locking system comprises two first legs and two second legs, said first legs being respectively extended from said inlet of said connection channel toward said outlet for the passing of said lower protruding blocks, said second legs being respectively horizontally extended from said first legs and adapted for abutting against the respective said lower protruding blocks tightly.

15. The cover as claimed in claim 14, wherein said locking system comprises two stop edges respectively located at respective rear sides of the respective said second legs.

16. The cover as claimed in claim 14, wherein said second legs each comprise a first supporting surface, a second supporting surface and a positioning portion, the said two first supporting surfaces being respectively extended from the said two first legs to respective front edges of the associating said positioning portions, the two said second supporting surfaces being respectively backwardly extended from respective opposing rear edges of the associating positioning portions, the two said lower protruding blocks being respectively abutted against the respective said second supporting surfaces.

17. The cover as claimed in claim 16, wherein the said front edge of each said positioning portion is a chamfered edge.

18. The cover as claimed in claim 16, wherein said locking system comprises two stop edges respectively located at respective rear sides of the respective said second legs.
